(19) United States
(12) Patent Application Publication
(10) Pub. No.: US 2014/0272897 A1
(43) Pub. Date: Sep. 18, 2014

(54) METHOD AND SYSTEM FOR BLENDING ASSESSMENT SCORES

(71) Applicants: Oliver W. Cummings, DeKalb, IL (US); Deborah Harris, Iowa City, IA (US)

(72) Inventors: Oliver W. Cummings, DeKalb, IL (US); Deborah Harris, Iowa City, IA (US)

(21) Appl. No.: 13/826,060

(22) Filed: Mar. 14, 2013

(51) Int. Cl. G09B 7/06

(52) U.S. Cl. CPC G09B 7/06
USPC 434/353

(57) ABSTRACT

A method and system for blending assessment scores for expressing the blended score as a single score while taking into account the non-compensatory nature of each assessment is disclosed. The method includes executing a test of a cognitive characteristic and a separate test of a non-cognitive characteristic. A cognitive test score and a non-cognitive test score are obtained from executing the test. The cognitive score and the non-cognitive score are blended using a non-compensatory blending scheme for outputting a blended score.

### BACKGROUND OF THE INVENTION

1. Field of the Invention

The present invention relates to blending different assessment scores. More specifically, but not exclusively, the present invention relates to methods and systems for blending assessment scores for expressing the blended score as a single score while taking into account the non-compensatory nature of each assessment.

2. Description of Prior Art

Conventional tests are generally focused either on cognitive knowledge and skills or on personal characteristics related to things like personality, values, and interests. At the same time it is well recognized that the interaction of cognitive knowledge and skills and the personal characteristics a person brings to a task is a dispositive determinant of success, in at least most cases. There is also a substantial body of research indicating that cognitive assessments are a strong predictor of performance, and the addition of information about a person's personality or other personal characteristics to the assessment adds to the strength of that prediction. While both assessments predict successful performance, the relationship is not such that one compensates fully for the other. In other words, a high level of a personal characteristic measure (i.e., non-cognitive ability) does not fully compensate for a low level of a knowledge or skill characteristic measure (i.e., cognitive ability).

Given the different nature of the test questions that often address the cognitive and non-cognitive characteristics and the fact that simply adding the assessment scores together does not reflect the non-compensatory nature of the traits measured, such measures are typically represented in different test instruments and yield separate assessment scores that may then be entered into predictive models to predict performance. This approach typically involves investing in two separate instruments, dealing with different processes for scoring and obtaining the data from the instruments and combining the results manually. Thus, costs are higher, more time is invested, and the lag time increases between when a person takes the assessments and when the information is used. Therefore, there are problems with typical prior art.

Therefore, it is a primary object, feature, or advantage of the present invention to improve upon the state of the art.

It is another object, feature, or advantage of the present invention to provide a method and system for blending assessment scores for expressing the blended score as a single score.

Yet another object, feature, or advantage of the present invention is to meet the key goals of blended scoring in a systematic manner.

A further object, feature, or advantage of the present invention is to eliminate the stochastic elements of combining assessment scores with a deterministic blend resulting from each assessment.

A still further object, feature, or advantage of the present invention is to provide a method and system for blended scoring that offers improved efficiency and is a more accurate predictor of success.

Another object, feature, or advantage of the present invention is to provide a blended score such that it becomes possible to make extremely accurate performance predictions.

Yet another object, feature, or advantage of the present invention is to provide a method and system for blending scoring resulting in a single score that is more deterministic than separate assessments of cognitive or personal characteristic measures taken alone.

A further object, feature, or advantage of the present invention is to insure that a blended score is arrived at by taking into account the non-compensatory nature of each assessment.

A still further object, feature, or advantage of the present invention is to provide a method and system for blending assessment scores in a test that allows for assembly of either linear or adaptive computer-based assessments.

One or more of these and/or other objects, features, or advantages of the present invention will become apparent from the specification and claims that follow.

### SUMMARY OF THE INVENTION

The present invention provides a blended scoring system resulting in a single score that is more deterministic than separate assessments of cognitive or personal characteristic measures taken alone. One exemplary system includes by computer implementation testing a cognitive characteristic and a non-cognitive characteristic. An independent cognitive score and a non-cognitive score results from testing. A score is output that includes a non-compensatory blend of the cognitive score and the non-cognitive score.

In another aspect, the invention is directed to a computer-assisted method for blending assessment scores that include amongst other things, at least one non-cognitive assessment. One or more tests are executed that include an assessment of a cognitive characteristic and a non-cognitive characteristic. A cognitive test score and a non-cognitive test score corresponding to the test for cognitive characteristics and non-cognitive characteristics is obtained from testing. The cognitive score and the non-cognitive score are blended using a non-compensatory blending scheme. One result that is output from the non-compensatory blending scheme is a blended score.

In a further aspect, the invention provides a non-compensatory method for blending assessment scores. The method, in one manner, may be performed by executing a computer implemented assessment that independently tests on cognitive characteristics and non-cognitive characteristics. By applying a scoring algorithm a score is calculated for each assessment, namely a cognitive assessment score and a non-cognitive assessment score. An optimization process is used to provide a set of interpretive scaling factors to define a set of blend parameters. The cognitive assessment score and the non-cognitive assessment score are blended resulting in a blended score based on the set of blend parameters. The blended score may, amongst other things, be provided as one output of the non-compensatory method for blending assessment scores.

### BRIEF DESCRIPTION OF THE DRAWINGS

Illustrative embodiments of the present invention are described in detail below with reference to the attached drawing figures, which are incorporated by reference herein and wherein:

FIG. 1 is a block diagram providing an overview of one embodiment of a system of the invention;

FIG. 2 is a block diagram providing an overview of an exemplary optimization process according to one aspect of the invention;

FIG. 3 is a block diagram providing an overview of an exemplary interpretive scaling process of the invention;

FIG. 4 is a block diagram providing an overview of an exemplary process for formulating a non-compensatory blending scheme of the invention;

FIGS. 5A and 5B provide a flow chart illustrating an exemplary embodiment of the methodology of the invention; and

FIG. 6 is a block diagram of a computer network and system in which an embodiment of the invention may be implemented.

### DETAILED DESCRIPTION OF THE PREFERRED EMBODIMENT

The present invention provides for a blended scoring system resulting in a single score that is more deterministic than separate assessments of cognitive or personal characteristic measures taken alone. One exemplary system includes by computer implementation testing a cognitive characteristic and a non-cognitive characteristic. An independent cognitive score and a non-cognitive score results from testing. A score is output that includes a non-compensatory blend of the cognitive score and the non-cognitive score.

### I. Introduction

According to one aspect, the invention may be implemented to create hybrid (cognitive and non-cognitive characteristics in the same instrument) tests that yield a single, non-compensatory score for the examinee. Exemplary uses of the non-compensatory scores produced may include, but are not be limited to the following:

1. Use either singly or in combination with other measures, providing a credential (e.g., evidence to demonstrate a qualification or competence) for individuals who have attained a certain level of combined competence in the content or subject matter of the test and personal characteristics that will most likely lead to appropriate use of the knowledge or skills attained, whether on a job, or in a learning environment (e.g., education or training);

2. Use either singly or in combination with other measures, screening for selection of individuals who best fit a given job requiring knowledge, skills, and personal characteristics tested (e.g., based on job specific information and end-user established cut-scores);

3. Use for identifying individuals who could most benefit from engaging in personal development related to the content area, discipline, practice, or topics tested.

### II. System

Conventional systems are generally focused either on cognitive knowledge and skills or on personal characteristics related to things like personality, values, and interests. The interaction of cognitive knowledge and skills and the personal characteristics a person brings to a task is a dispositive determinant of success, in at least most cases. Since cognitive assessment systems are a strong predictor of performance, and the addition of information about a person's personality or other personal characteristics to the assessment system adds to the strength of a prediction provided by a system. Although for example, both assessments may predict successful performance, the system configured relationship is not such that one compensates fully for the other. In other words, systems of the invention are configured so that a high level of a personal characteristic measure (i.e., non-cognitive ability) does not necessarily fully compensate for a low level of a knowledge or skill characteristic measure (i.e., cognitive ability).

Given the different nature of the test questions that often address the cognitive and non-cognitive characteristics, simply using a system to add the assessment scores together does not reflect the non-compensatory nature of the traits measured. Therefore, a system that measures these traits, which are typically represented in different test instruments and yield separate assessment scores, may be configured to account for the non-compensatory nature of both using predictive models to predict performance. The invention then, configured according to one aspect, provides a system for blending assessment scoring resulting in a single score that is more deterministic than separate assessments of cognitive or personal characteristic measures taken alone.

### 1. Overview

FIG. 1 illustrates one embodiment of a system of the invention. The various components shown in FIG. 1 may be used to configure a system 10 to provide to blend assessment or test scores resulting in a single score. In exemplary configuration, a master control routine 12 interacts with one or more of the other components, which include, for example, cognitive assessment test(s) 14, non-cognitive assessments test(s) 16, apply scoring algorithm 18, interpretative scaling 20, optimization process 22, formulate non-compensatory blending scheme 24, blend assessment test scores 26, validation 28, and data log 30 to output blended score 32. The master control routine 12 may also be configured to operate computer network and system 200 illustrated in FIG. 6. For example, any one of the aforementioned components or routines may be executed by the computer network and system 200. A system 10 includes a number of cognitive assessment tests 14 and non-cognitive assessment test 16 which may be appropriately selected, for example, by the master control routine 12. The cognitive assessment test 14 may include a test administration script executing one or more selected items for testing or assessing an individual's knowledge and skill relating, for example, to a specific application (e.g., teamwork orientation, supervisory orientation, interpersonal orientation, and like orientations). Similarly, the non-cognitive assessment test 16 may be selected using a test administration script executing a series of selected items for testing or assessing an individual's personal traits or characteristics (e.g., personality). The system 10 could be configured to execute a computer implemented (see, e.g., computer network and system 200 shown in FIG. 6) set of cognitive assessment tests 14, each having a cognitive score metric as an output. Similarly, system 10 could be configured to provide a computer implemented test using computer network and system 200 shown in FIG. 6 to execute a series of non-cognitive assessment tests, which include an output comprising a score indicator as a performance metric of each test. The master control routine 12 may be configured to apply scoring algorithm to each assessment test 18 for providing an output metric indicating performance on each test, namely a cognitive assessment test 14 and a non-cognitive assessment test 16. Given that the performance metrics by which the cognitive assessment test 14 and non-cognitive assessment test 16 may be assessed or scored on different scales, the system 10 may be configured to provide some interpretive scaling 20 to one or both of the score outputs from the cognitive assessment test 14 and non-cognitive assessment test 16. For example, assessment metrics associated with the non-cognitive tests may be scaled differently than assessment metrics associated with the cognitive assessment tests 14. In one practical application, cognitive based components (e.g., knowledge and skill) may be assessed using multiple choice items whereas non-cognitive based components (e.g., personality) may be assessed using Likert-type items which if not scaled may introduce some psychometric problems. Some proposed solutions, according to exemplary aspects of the invention, for matching cognitive and non-cognitive assessment scales include, but are not limited to, interpretative scaling 20 that:

1. Weighs scales based on theoretical rationale and simplicity;

2. Leaves scaling the same as provide by the output of the cognitive assessment test 14 and non-cognitive assessment test 16; and

3. Weighs the output of the cognitive assessment test 14 and the non-cognitive assessment test 16 according to different scales, such as for example, weighing according to test time, equal weighting, the number of raw score points for each item type, unweighted raw score scoring, item response theory (IRT) pattern scoring, linear additive modeling, and regression weighted versus unit weighting factors.

### 1. Interpretive Scaling Process

FIG. 2 provides a pictorial representation illustrating other exemplary interpretative scaling 20 processes of the present invention. Process 50 providing interpretative scaling 20 includes, for example, weighting at least one of the score outputs from the cognitive assessment tests 14 and non-cognitive assessment tests 16 based on a statistical range (e.g., delta “A”) of separation between the cognitive score “CS” and non-cognitive score “NS.” Another process 52 for providing interpretative scaling 20 includes scaling at least one of the score outputs from the cognitive assessment test 14 and non-cognitive assessment test 16 based on a statistical rank of the cognitive score “CS” relative to a test range for the cognitive scores resulting from the cognitive assessment test 14. Another process 54 for providing interpretative scaling 20 includes scaling one or more of the score outputs from the cognitive assessment test 14 and non-cognitive assessment test 16 by basing a scaling factor on a statistical rank of the non-cognitive score “NS” relative to a test score range for the non-cognitive scores from the cognitive assessment test 14. Any one or more of the interpretative scaling 20 processes 50, 52, 54, or those previously described may be executed, operated, managed, and logged using any one or more of the components of the computer network and system 200 illustrated in FIG. 6.

### 2. Non-Compensatory Blending Scheme Process

FIG. 3 provides a block diagram illustrating exemplary aspects of the process for formulating a non-compensatory blending scheme 24 of the present invention. The non-compensatory blending scheme may be represented by a formula, algorithm, or other theoretical rationale. One possible formulaic rationale is illustrated by way of a chart representing a score map for both cognitive scores 58 and non-cognitive scores 60. The cognitive scores 58 are on the Y-axis and for purposes of illustration are scaled, for exemplary purposes, having a range from 0 to 60. The non-cognitive scores 60 are shown on the X-axis with an exemplary scale ranging from A to Z. Portions of both the cognitive scores 58 and the non-cognitive scores 60 along the Y and X axes respectively have been redacted only for purposes of illustration and simplicity, but not to limit or otherwise narrow the example. According to the illustrated embodiment of the non-compensatory blending scheme 24 shown in FIG. 3, the various combinations of cognitive 58 and non-cognitive scores 60 are mapped into a scale. The scale mapping may be performed, for example, using the interpretative scaling 20 illustrated in FIG. 2. For purposes of illustration, one may assume that based on the scale of the Y-axis that the cognitive scores 58 run from 0 to 60, and the non-cognitive scores 60 run from A to Z. A reporting scale or output blended score (see, e.g., scores 56 and 62) is shown with an exemplary scale ranging from 100 to 200. Each one of the cells in the chart (see, e.g., 56 and 62) represent a blended score representing how the combination of the scores map into a single reported score, such as blended score 56 and blended score 62. If the scores used in each of the subcomponents, namely the cognitive score subcomponent and the non-cognitive score subcomponent are scaled scores, such as for example, resulting from the interpreting scaling process 20 shown in FIG. 2, a similar table or the same table may be used for all forms. Table 1 below provides exemplary score mapping numbers for a set of cognitive and non-cognitive test scores, which result in a reported score or a blended score.

TABLE 1
Blended Score Map

| Cognitive | Non-Cognitive | Blended Score |
|---|---|---|
| 0 | A | 100 |
| 1 | A | 100 |
| 2 | A | 101 |
| 60 | A | 180 |
| 0 | B | 101 |
| 1 | B | 102 |
| 60 | Z | 200 |

Viewing the chart illustrated in FIG. 3 and Table 1, one can see that the blended score is non-compensatory. Note for example, a cognitive score of 60 and a non-cognitive score of A may not result in a blended score of 200, but will likely result in a blended score of something less than 200, such as between 170 and 185, or perhaps closer to 180. Similarly, as shown in the map illustrated in FIG. 3, a cognitive score of zero and a non-cognitive score of Z does not result in a blended score of 200 but, for example, may result in a score greater than 100 but not greater than 150. Thus, the blended score map illustrated in FIG. 3 and further supported by Table 1 illustrates the non-compensatory nature of blending scheme 24. The score map illustrating blended scores for various scales of cognitive scores 58 and non-cognitive scores 60 is but one example of a process for formulating a non-compensatory blending scheme 24 according to an aspect of the invention. An underlying algorithm, formula or theoretical rationale for each of the blends in the score mapping process may be configured to change based on a collection of data. For example, to establish the validity of the underlying algorithm, formula or theoretical rationale simulated data may be collected and used to prove out the formula for non-compensatory blending 24 until real test data can be used to prove out and validate the underlying metrics of the blended score mapping process.

### 3. Optimization Process

FIG. 4 provides a block diagram illustrating an optimization process 22 according to an exemplary aspect of the invention. The master control routine 12 may be configured to execute, manage and data log information from the optimization process 22 using, for example, a computer implemented process supported by the computer network and system 200 shown in FIG. 6. A set of inputs may be used to provide the optimization process 22 to formulate non-compensatory blending scheme 24. The inputs may be a series of inputs, a set of inputs or an individual input (N, N+1, N+2 . . . ). The inputs 48 to the optimization process 22 are used to optimize the non-compensatory nature of the blending scheme 24. Exemplary inputs 48 to the optimization process 22 include test statistics 42, test specifications 44, score scaling 46, clinical judgment 38, test construct 36, empirical data 34, and non-compensatory controls 40. Other examples may include adjusting or optimizing the scoring algorithm 41 for applying to each test. For example, test statistics 42 may be used to develop a statistical characteristic of each test. Similarly, a test construct 36 may be defined by a set of test specifications 44 for formulating an input 48 to the optimization process 22. Likewise, a series of clinical judgments 38 may be employed which assign an interpretative scale 46 to the non-cognitive score 60. These inputs 48 and other inputs may be used for the non-compensatory blending scheme 24. Upon completion of the blend assessment test scores 26 illustrated in FIG. 1, a validation process 22 may be executed using the master control routine 12. The validation process 28 may be a computer implemented validation process using, for example, the computer network and system 200 illustrated in FIG. 6. The system 10 provides an output blended score 32 as a performance indicator for combined cognitive and non-cognitive scores.

### III. Methodology

A simplified example of one embodiment of the present invention is described below. The present invention is not to be limited in this particular embodiment, as one skilled in the art having the benefit of this disclosure would understand numerous variations and modifications that can be performed.

### 1. Blending Assessment Scores

FIGS. 5A and 5B illustrate an overview of one method for blending scoring. The method shown in FIGS. 5A and 5B is used to blend cognitive and non-cognitive test scores to provide an improved or statistically greater chance of predicting performance. In step 100 of FIG. 5A, the blending process begins with the selection of a cognitive test 102. The cognitive test 102 selects items for assessing an individual's knowledge and skill. Also, but not necessarily simultaneously, a non-cognitive test 104 is selected. The non-cognitive test 104 includes an assessment of character traits or qualities (e.g., personality). For purposes of addressing each of the steps illustrated in FIG. 5A, steps relating to the cognitive tests and non-cognitive tests will be discussed in parallel, however this is not to imply that both tests need to be administered in parallel or simultaneously. Upon selection, each test is executed, specifically the cognitive test is executed at step 106 and the non-cognitive test is executed at step 108. Each test may be a computer executed step performed at least in part by operation of computer network and system 200 shown in FIG. 6. After each test is completed, they are scored (i.e., a scoring algorithm is applied to each). In step 110, the cognitive test is scored and in step 112 the non-cognitive test is scored. At step 114 and 116 interpretative scaling is applied to the cognitive score and the non-cognitive score. An example of interpretive scaling is illustrated in FIG. 2 and described in above. Since a cognitive test may be scored on a different scale than a non-cognitive test, or vice-versa, the interpretative scaling step 114 and interpretative scaling step 116 is applied in advance of formulating a blend scheme. At step 118, the system includes formulating a blend for the cognitive test and at step 120 formulating a blend for the non-cognitive test. A blending scheme 24 such as the one illustrated in FIG. 3 and described above may be used to provide an underlying formula, algorithm or theoretical rationale whereby the two scores are blended to provide a stronger indicator of performance, rather than assessing each individually or separately. Next in steps 122 and 124 in FIG. 5B, the blend is optimized for the cognitive score and the blend is optimized for the non-cognitive score. An example of an optimization process 22 is shown in FIG. 4 and described above. In step 126 the cognitive and non-cognitive scores are blended together to provide a blended score as an output at step 128. Other steps may be included in the method, such as for example, those indicated in FIG. 1 of the system of the invention. Validation steps and data logging steps as well as others may be included in the method steps for outputting a blended assessment score of a cognitive test (e.g., testing knowledge and skill) and a non-cognitive test (e.g., testing personality characteristics and traits).

### IV. Computer Network and System

FIG. 6 is a block diagram of a computer network 200 in which an embodiment of the invention may be implemented. As shown in FIG. 6, the computer network 200 includes, for example, a server 226, workstation 230, scanner 232, a printer 228, a data store 210, and networks 216. The computer networks 216 are configured to provide a communication path for each device of the computer network 200 to communicate with other devices. Additionally, the computer networks 216 may be the internet, a public switchable telephone network, a local area network, private wide area network, wireless network, and any of the like. In various embodiments of the invention, an automated score blending application (“SBA”) 236 may be executed on the server 226 and/or workstation 230. For example, in one embodiment of the invention, the server 226 may be configured to execute the SBA 236, provide outputs for display to the workstation 230, and receive inputs from the workstation 230. In various other embodiments, the workstation 230 may be configured to execute the SBA 236 individually or co-operatively with one or more other workstations. The scanner 232 may be configured to scan textual content and output the content in a computer readable format. Additionally, the printer 228 may be configured to output the content to a print media, such as paper. Furthermore, data associated with cognitive assessment test; non-cognitive assessment test; assessment score; interpretative scaling of assessment scores; optimization process; non-compensatory blending scheme; validation; and the like, may be stored on the datastore 210. The datastore 210 may additionally be configured to receive and/or forward some or all of the stored data. Moreover, in yet another embodiment, some or all of the computer network 200 may be subsumed within a single device.

Although FIG. 6 depicts a computer network, it is to be understood that the invention is not limited to operation within a computer network, but rather, the invention may be practiced in any suitable electronic device. Accordingly, the computer network depicted in FIG. 6 is for illustrative purposes only and thus is not meant to limit the invention in any respect.

FIG. 6 also illustrates a block diagram of the computer system 200 in which an embodiment of the invention may be implemented. As shown in FIG. 6, the computer system 200 includes a processor 214, a main memory 218, a mouse 220, a keyboard 224, and a bus 234. The bus 234 may be configured to provide a communication path for each element of the computer system 200 to communicate with other elements. The processors 214 may be configured to execute a software embodiment of the SBA 236. In this regard, a copy of computer executable code for the SBA 236 may be loaded in the main memory 218 for execution by the processor(s) 214. In addition to the computer executable code, the main memory may store data, including cognitive assessment data, non-cognitive assessment data, assessment test scores, interpretative scaling formulas, algorithms or theoretical solutions, optimization parameters or metrics, non-compensatory blending schemes, validation processes or codes, tables of data, and any of the like. In operation, based on the computer executable code for an embodiment of the SBA 236, the processor(s) 214 may be received by a display adaptor (not shown) and converted into display commands configured to control the display 212. Furthermore, in a well-known manner, the mouse 220 and keyboard 224 may be utilized by a user to interface with the computer system 200. The networks 216 may include a network adaptor (not shown) configured to provide two-way communication between the networks 216 and the computer system 200. In this regard, the SBA 236 and/or data associated with the SBA 236 may be stored on the networks 216 and accessed by the computer system 200.

### V. Other Embodiments and Variations

The present invention is not to be limited to the particular embodiment described herein. In particular, the present invention contemplates numerous variations in the type of test, whether the test is a linear or adaptive computer-based test. The invention is not limited to particular types of cognitive and non-cognitive tests, or one cognitive test and one non-cognitive test. Although a blended score is described as one derived from assessment metrics combined from both cognitive and non-cognitive tests, the invention contemplates score blending various assessment metrics that would result in a more accurate prediction by applying the non-compensatory blending schemes of the present invention. The present invention also contemplates variations in the particular properties used in order to develop an underlying formula, algorithm or theoretical rationale for the blending scheme(s). The present invention contemplates that an optimization function may or may not be used and where used can vary for each blend scheme. The present invention contemplates that scoring can be accomplished in various ways and that performance differences on unrelated subscales may be resolved into a composite expected score or logit measure, which can be compared to an original standard thereby making it possible to update tests and change their overall difficulty without losing the ability to compare scores on the original composite standard. Processes used to produce a blending scheme for providing interim estimates may or may not be the same as the process used to produce the final blended score. One skilled in the art having the benefit of this disclosure will understand that there are numerous other variations of the present invention not articulated herein, but nevertheless within the spirit and scope of the invention.

What is claimed is:

1. A blended scoring system comprising:
a computer implemented test of a cognitive characteristic comprising a cognitive score;
a computer implemented test of a non-cognitive characteristic comprising a non-cognitive score; and
a score output comprising a non-compensatory blend of the cognitive score and the non-cognitive score.

2. The blended scoring system of claim 1 further comprising a scaling factor applied to the non-compensatory blend, the scaling factor adjusted by one of:
a. a difference between the cognitive score and the non-cognitive score;
b. a rank of the cognitive score relative to a test score range for the cognitive scores;
c. a rank of the non-cognitive score relative to a test score range for the non-cognitive scores.

3. The blended scoring system of claim 1 further comprising a formula having an input selected from the cognitive score and the non-cognitive score and a corresponding output comprising a scaled cognitive score and a scaled non-cognitive score for creating the non-compensatory blend.

4. The blended scoring system of claim 1 wherein the non-compensatory blend is a computer-based blend.

5. The blended scoring system of claim 1 further comprising a formula having a set of elements comprising at least one of:
a. a statistical characteristic of the computer implemented test;
b. a test construct defined by a set of specifications;
c. a series of clinical judgments assigning an interpretive scale to the non-cognitive score.

6. The blended scoring system of claim 1 wherein the test of cognitive characteristics comprise a skill assessment and/or a knowledge assessment.

7. The blended scoring system of claim 1 wherein the test of non-cognitive characteristics comprise an assessment of personal characteristics.

8. A computer-assisted method for blending assessment scores comprised of at least one non-cognitive assessment, the computer-assisted method comprising:
executing a test of a cognitive characteristic and a non-cognitive characteristic;
obtaining a cognitive test score and a non-cognitive test score corresponding to the test for cognitive characteristics and non-cognitive characteristics;
blending the cognitive score and the non-cognitive score using a non-compensatory blending scheme; and
outputting a blended score from the non-compensatory blending scheme.

9. The computer-assisted method of claim 8 further comprising applying a scaling factor in the non-compensatory blending scheme.

10. The computer-assisted method of claim 9 further comprising basing the scaling factor, at least in part, on:
a. a statistical range of separation between the cognitive score and non-cognitive score;
b. a statistical rank of the cognitive score relative to a test score range for the cognitive scores;
c. a statistical rank of the non-cognitive score relative to a test score range for the non-cognitive scores.

11. The computer-assisted method of claim 8 further comprising accounting for scaling differences between a cognitive scoring scale of the cognitive assessment and non-cognitive scoring scale of the non-cognitive assessment in the non-compensatory blending scheme.

12. The computer-assisted method of claim 8 further comprising expressing the non-compensatory blending scheme as a formula having a set of elements comprising at least one of:
a. a statistical characteristic of each test;
b. a test construct defined by a set of specifications;
c. a series of clinical judgments assigning an interpretive scale to the non-cognitive score.

13. The computer-assisted method of claim 8 further comprising applying an optimization process to control statistical properties of the non-compensatory blending scheme.

14. The computer-assisted method of claim 8 wherein the test of non-cognitive characteristics comprise an assessment of personal characteristics.

15. The computer-assisted method of claim 8 wherein the test of a cognitive characteristics and non-cognitive characteristics is a computer-based test.

16. A non-compensatory method for blending assessment scores, comprising:
executing a computer implemented assessment for independently testing a cognitive characteristic and a non-cognitive characteristic;
calculating a score for each assessment comprising a cognitive assessment score and a non-cognitive assessment score;
applying an optimization process to provide a set of interpretive scaling factors to define a set of blend parameters;
blending the cognitive assessment score and the non-cognitive assessment score based on the set of blend parameters to provide a blended score; and
outputting the blended score.

17. The non-compensatory method of claim 16 further comprising basing the interpretive scaling factors, at least in part on:
a. a statistical range of separation between the cognitive assessment score and non-cognitive assessment score;
b. a statistical rank of the cognitive assessment score relative to a range for the cognitive assessment scores;
c. a statistical rank of the non-cognitive score relative to a range for the non-cognitive assessment scores.

18. The non-compensatory method of claim 16 further comprising accounting for scaling differences between the cognitive assessment score and the non-cognitive assessment score in the interpretive scaling factors.

19. The non-compensatory method of claim 16 further comprising running an article of software on a computer for executing the computer implemented assessment.

20. The non-compensatory method of claim 16 wherein the non-cognitive characteristic comprises an assessment of personal characteristics and the cognitive characteristic comprises an assessment of skill or knowledge.
